(19) United States
(12) Patent Application Publication
(10) Pub. No.: US 2026/0329820 A1
(43) Pub. Date: Oct. 22, 2026

(54) PROTOCOL FOR MIGRATION OF DATA BETWEEN QUALITY MANAGEMENT SYSTEMS

(71) Applicant: Honeywell International Inc., Charlotte, NC (US)

(72) Inventors: Shaun Vallejo, Red Bank, NJ (US); Jonathan Astemborski, Moorestown, NJ (US)

(21) Appl. No.: 19/185,245

(22) Filed: Apr. 22, 2025

(51) Int. Cl. G06F 16/21; G06F 21/62; G06F 40/169

(52) U.S. Cl. CPC G06F 16/214; G06F 21/6218; G06F 40/169

(57) ABSTRACT

Examples techniques for migrating data from a source Quality Management System (QMS) to a destination QMS are described. A standardized protocol comprising a set of rules to be applied to data to be migrated is defined. The set of rules defines plurality of configuration elements for quality control processes implemented in a QMS to manage lifecycle of a product, comprising at least workflow definitions for workflows defined for quality control processes. The workflow definition comprises a sequence of stages and actions for quality control processes, including transition rules, fields, and configuration of fields for each stage. The transition rules for a stage define transition of objects corresponding to records in data from one state to another as a result of one or more actions for compliance with regulatory requirements governing the product. The standardized protocol is provided to a device for migration of data from source QMS to destination QMS.

### BACKGROUND

A Quality Management System (QMS) is a formalized system that defines and documents processes, procedures, and responsibilities for an organization to achieve quality policies and objectives. It assists in coordinating and directing an organization's activities to meet customer and regulatory requirements and improve its effectiveness and efficiency on a continuous basis. An eQMS (Electronic Quality Management System) is a digital version of QMS or a software platform used by organizations, particularly in regulated industries like pharmaceuticals, medical devices, and aerospace, to manage, automate and streamline quality-related processes and documentation in a digital manner.

The eQMS manages and controls documents and records to ensure they are current, accessible and verified. The eQMS implements effective quality control measures to achieve predefined quality policies and objectives of the organization and monitors performance of various ongoing processes within the organization to ensure compliance with quality standards, such as ISO and FDA regulations. It also identifies and addresses areas for improvement in order to achieve operational efficiency, reduce errors and waste of resources, improve customer satisfaction, manage corrective actions and maintain compliance with industry regulations and standards. The eQMS enables real-time data access to allow transparency in the various stages of the production process. For instance, if unexpected results are identified during checks of a batch of medication, an eQMS can instantly alert the quality team to allow the team to quickly investigate and implement changes or pause production.

Also, eQMS makes the tracking and management of compliance documents quickly accessible to audit person. A key feature of an eQMS is its database, which enables document tracking, audit management, and compliance with standards like ISO and FDA regulations. When transitioning to a new eQMS, data stored in the database of existing eQMS needs to be correctly mapped to the corresponding fields in the database of new eQMS in order to avoid any discrepancy in the data.

### SUMMARY

Various embodiments of systems, methods, and non-transitory computer-readable media for migrating data from a source Quality Management System (QMS) to a destination QMS are described herein.

The details of some embodiments of the subject matter described in this specification are set forth in the accompanying drawings and the description below. Other features, aspects, and advantages of the subject matter will become apparent from the description, the drawings, and the claims.

According to an embodiment of the present subject matter, a system for migrating data from a source QMS to a destination QMS is provided. The system comprises a processor. The processor defines a standardized protocol comprising a set of rules to be applied to the data to be migrated. The set of rules defines a plurality of configuration elements for quality control processes implemented in a QMS to manage stages of lifecycle of a product. The plurality of configuration elements comprises at least workflow definitions corresponding to workflows defined for the quality control processes. The workflow definition comprises a defined sequence of stages and actions for the quality control processes, including transition rules, one or more fields, and configuration of fields for each stage. The transition rules corresponding to a stage define transition of one or more objects corresponding to electronic records in the data from one state to another as a result of one or more actions for compliance with regulatory requirements governing the product. The processor provides the standardized protocol to a device for migration of data from the source Q MS to the destination QMS. The device uses the standardized protocol for migrating data from the source QMS to the destination QMS.

According to an embodiment of the present subject matter, a method for migrating data from a source QMS to a destination QMS is described. According to the method, for a plurality of configuration elements of a quality control process implemented in a source QMS to manage stages of lifecycle of a product, a standardized protocol is defined. The standardized protocol comprises a set of rules to be applied for migrating data of the source QMS to destination QMS. The plurality of configuration elements comprises at least workflow definitions corresponding to workflows defined for the quality control process. The workflow definition comprises a defined sequence of stages and actions for the quality control process, including transition rules, one or more fields, and configuration of fields for each stage. The transition rules corresponding to a stage define transition of one or more objects corresponding to electronic records in the data of the source QMS from one state to another as a result of one or more actions for compliance with regulatory requirements governing the product. The standardized protocol is provided to a device for migration of data of the source QMS from the source QMS to the destination QMS. The device may use the standardized protocol to migrate data of the source QMS to the destination QMS.

According to yet another embodiment of the present subject matter, a non-transitory computer-readable medium comprising instructions executable by a processing resource to migrate data from a source QMS to a destination QMS is provided. The instructions, when executed, cause the processing resource to define a JSON-based standardized protocol comprising a set of rules to be applied to data of a source Quality Management System (QMS) to be migrated to a destination QMS. The set of rules defines a plurality of configuration elements for quality control processes implemented in the source QMS to manage stages of lifecycle of a product. The plurality of configuration elements comprises at least workflow definitions corresponding to workflows defined for the quality control processes, object definitions and permission set definitions. The workflow definition comprises a defined sequence of stages and actions for the quality control processes, including transition rules, one or more fields, and configuration of fields for each stage. The transition rules corresponding to a stage define transition of one or more objects corresponding to the data of the source QMS from one state to another as a result of one or more actions for compliance with regulatory requirements governing the product. The object definitions comprise a data structure of an electronic record representing the data, including fields with defined data types, field attributes, audit trail configurations, and presentation layouts. The permission set definitions comprise a collection of access rights and restrictions defining user actions within the QMS, including read, write, and delete permissions for objects and fields, and access rights for the workflows. The instructions further cause the processing resource to provide the standardized protocol to a migration device for migration of the data from the source QMS to the destination QMS.

### BRIEF DESCRIPTION OF FIGURES

The following detailed description references the drawings, wherein:

FIG. 1 illustrates a schematic representation of an environment for implementing example techniques for migrating data from a source QMS to a destination QMS, in accordance with an example implementation of the present invention;

FIG. 2 illustrates a system for migrating data from a source QMS to a destination QMS, in accordance with an example implementation of the present invention;

FIG. 3 illustrates the system for migrating data from the source QMS to the destination QMS, in accordance with another example implementation of the present invention;

FIG. 4 illustrates a signal flow in a process to migrate data from the source QMS to the destination QMS, in accordance with an example implementation of the present invention;

FIG. 5 illustrates a method for migrating data from a source QMS to a destination QMS, according to an example of the present invention;

FIG. 6 illustrates a method for defining plurality of configuration elements of a QMS, according to an example implementation of the present invention;

FIG. 7 illustrates a method for migrating data from the source QMS to the destination QMS, according to another example implementation of the present invention;

FIG. 8 illustrates a computing environment system for migrating data from a source QMS to a destination QMS, according to an example implementation of the present invention.

In the figures, the left-most digit(s) of a reference number identifies the figure in which the reference number first appears. The same numbers are used throughout the drawings to reference like features and components.

### DETAILED DESCRIPTION

As described, the primary objective of an eQMS in an organization is to ensure that the organization's products, services, and processes consistently meet customer expectations and regulatory requirements while improving overall efficiency. To achieve these objectives eQMS includes features such as document control, change management, training management, corrective and preventive actions (CAPA), risk management, audits management, and others. For instance, the eQMS, via implementing the feature of document control, manages and stores all essential documents related to processes carried out in the organization to make the latest versions of documents quickly accessible to concerned or authorized individuals or quality personnels. For example, research trial reports related to medicinal formulation may be stored and categorized for quick and easy accessibility. To implement a feature, an eQMS generally defines workflows. For instance, since multiple people collaborate together on authoring, reviewing and approving a document, a document control workflow may specify roles, steps, rules, approvals, and decisions for every document when created or updated. The workflow may be executed every time a new document is created or is to be updated.

For some products, quality management is a regulated process and has specific regulatory requirements that manufacturers of the products need to comply with. An eQMS provides for compliance with regulations, guidelines, and standards that define requirements applicable to companies operating in specific industries, such as pharmaceuticals, biotechnological, or medical devices. One example for such a regulatory requirement may be that a complaint for a medical device submitted by a consumer needs to be digitally signed by the complainant. Another example of a regulatory requirement that an eQMS may need to comply with, is that once the complaint has been made and the same is under assessment by regulatory authorities, the associated records are to be locked for editing and cannot be amended by anyone. The United States Food and Drug Administration (FDA) 21 CFR Part 11 is a regulation that intends to ensure electronic records and electronic signatures' integrity, reliability, and authenticity. According to 21 CFR Part 11, the manufacturers must have controls and procedures to ensure electronic records' authenticity, integrity, and confidentiality, if required. These procedures and controls may include system validation checks to ensure accuracy, consistent intended performance, reliability and the ability to identify invalid or altered records and ability to generate or export accurate and complete copies of records for inspection, review, and copying by the FDA. The procedures and controls may also include ability to generate a secure audit trail that includes any changes made to electronic records; workflow automation to verify and ensure that the sequence of events is followed correctly; authority checks to ensure that only authorized individuals can use the system functions, electronically sign a record, access the computer system input or output device, modify a record and perform assigned tasks in the system; and ability to capture signature information associated with electronically signing a document. The database of the eQMS is designed to cater to the above specific requirements. When an organization decides to switch to a new eQMS, for example, from an on-premise eQMS to an eQMS implemented on a cloud platform, electronic records are migrated from the existing eQMS to the new eQMS. Numerous migration tools exist for migration of an application from one platform to another or to migrate data handled by an QMS application to a new application. However, since QMS is required to comply with regulatory requirements and there is no standard format available for the configuration of records in an eQMS, use of the existing migration tools for migration of an eQMS is not viable. Thus, migration of records to the new e-QMS is generally performed manually. Manual migration is very tedious, costly and error prone process, since properties such as digital signatures, lock state, audit trails need to be correctly associated with corresponding records. Also, since records are configured on every platform in a different manner, manual migration of configuration of various fields and workflows to the new eQMS may lead to inconsistencies in the records migrated to the new eQMS, hereinafter referred to as a QMS.

According to example implementations of the present subject matter, techniques for migrating data from a source QMS to a destination QMS, addressing the above-described shortcomings in the migration are described.

In accordance with example embodiments of the present subject matter, techniques for migrating data from a source QMS to a destination QMS comprises defining a standardized protocol. The standardized protocol may be defined for migration of the data pertaining to quality control processes defined in a QMS implemented to manage stages of lifecycle of a product. The protocol comprises a set of rules to be applied to the data to be migrated. The set of rules defines a plurality of configuration elements for the quality control processes. Workflows are defined in the eQMS to execute the quality control processes. A workflow corresponding to a quality control process may comprise plurality of stages and one or more actions to accomplish a task may be performed during each stage. The plurality of configuration elements comprises at least workflow definitions corresponding to workflows for the quality control processes.

In an example, the workflow definition comprises a defined sequence of stages and actions for the quality control processes, including transition rules, one or more fields, and configuration of fields for each stage. The transition rules corresponding to a stage define transition of one or more objects corresponding to electronic records in the data from one state to another as a result of one or more actions for compliance with regulatory requirements governing the product. For instance, a transition rule may define that a record needs to be digitally signed for compliance with regulatory requirements. The action of applying a digital signature to an object corresponding to that record may change the state of the record from unverified to verified. The standardized protocol may be provided to a device for migration of data from the source QMS to the destination QMS.

The set of rules in the standardized protocol defines a common or standard format for configuration elements of the QMS. For migration of data from the source QMS to the destination QMS, a device capable of understanding the format defined in the rules may extract the configuration elements of the source QMS in the standard format and map the extracted elements to the destination QMS. Since the rules are defined considering the regulatory requirements that the QMS needs to be complied with, such as audit trails, digital signature or lock states, the elements including constraints corresponding to such requirements may be accurately extracted and mapped to the destination QMS. Thus, the complexity associated with migration of data from source QMS to destination QMS is reduced and efficiency of the process of migration is increased by obviating the chances of errors that may occur during manual process of migration.

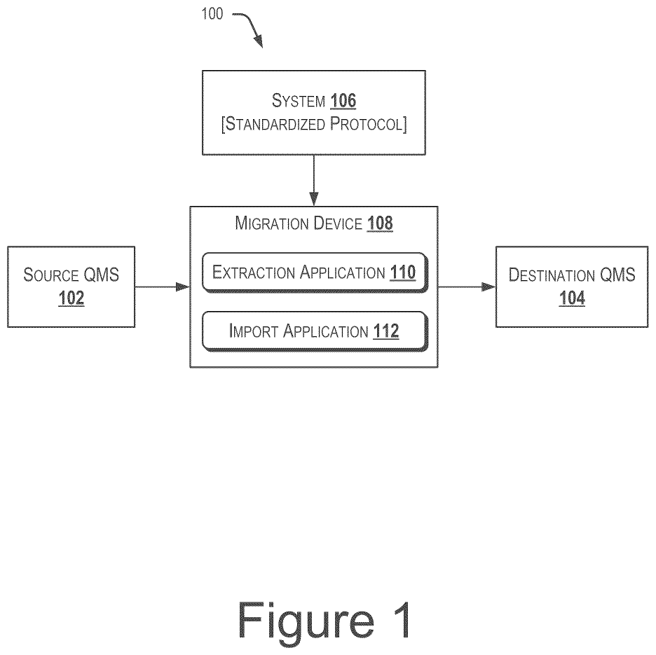

The above techniques are further described with reference to FIG. 1 to FIG. 8. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a schematic representation of an environment 100 for implementing examples techniques for migrating data from a source QMS to a destination QMS, in accordance with an example implementation of the present invention.

In an example implementation of the present subject matter, the environment 100 may comprise a source QMS 102 implemented within an organization. The organization may be manufacturer of products, such as pharmaceutical drugs and medical devices. The environment 100 may also comprise a destination QMS 104 to be implemented within the organization.

The source QMS 102 and the destination QMS 104 may be computing devices, such as a server, a desktop computer, laptop, smartphones, or a tablet. Each of the source QMS 102 and the destination QMS 104 may comprise one or more processors for executing instructions to implement quality control processes for managing lifecycles of products within the organization. In an example, the processor may be implemented as microprocessors, microcomputers, microcontrollers, digital signal processors, central processing units, state machines, logic circuitries, and/or any devices that manipulate signals based on operational instructions. Each of the source QMS 102 and the destination QMS 104 may also comprise a memory for storing the instructions executable by the one or more processor. The instructions may cause the processor to execute quality control processes implemented therein. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In another example, the source QMS 102 and/or the destination QMS 104 may be a standalone server or maybe a remote server on a cloud computing platform. In an embodiment, the server may be a cloud-based computing system. The computing system may include one or computing device, such as those in a distributed computing system. The source QMS 102 and the destination QMS 104 may comprise one or more processing units, one or more storage devices, such as memory units, for storing data and machine-readable instructions for example, applications and application programming interfaces (APIs), and other peripherals required for providing cloud computing functionality.

As discussed, an eQMS is a digital solution designed to streamline and automate the management of quality control processes within an organization. By digitizing and automating processes such as document control, audit management, risk management, complaints management and corrective and preventive actions, an eQMS improves efficiency, accuracy, traceability, and compliance. These improvements enable organizations to better manage product quality, respond to issues more swiftly, and maintain high standards, all while reducing the risk of human error and administrative burdens.

The fundamental feature of eQMS is its database, which enables the functionality of eQMS. The database of the eQMS is designed to comply with the regulatory requirements such as FDA 21 CFR Part 11 that aims to ensure electronic records and electronic signatures' integrity, reliability, and authenticity. For example, these requirements may include secure, automated and time stamped audit trail entries corresponding to electronic records to indicate changes made to electronic record during entire retention period of the record, who performed the change, the prior and subsequent values of the record, and an explanation as to the reason for the change. The requirements may also include limited access to unauthorized personnel, and authority checks to ensure only authorized individuals have access to the system, can electronically sign records, alter records, or perform certain operations. Furthermore, the requirements may also dictate that electronic signatures on electronic records must be securely linked to their corresponding records to prevent removing, copying, or transferring the signature to forge a record.

Workflows corresponding to various quality control processes are implemented in the eQMS to perform the respective process. The database of the eQMS comprises one or more records that may be associated with a workflow and each record may have associated fields that may be updated or used during execution of various stages of the workflow. For example, in a document control workflow, various fields are used to track, manage, and control documents through their lifecycle. These fields help in ensuring that documents are properly stored, updated, and accessible to the right stakeholders at the right time. These fields may include document ID or reference number, type of document, e.g., policy, procedure, form, report, or specification, version number, date of issue or creation, date of last revision, document status, approver or author and confidentiality or access level. Fields may further include an audit trail that tracks any changes or revisions made to the document, including what was changed and who authorized the change, comments or notes added to the document, locked state to specify if the document is locked to prevent any editing. These fields may be updated along execution of various stages of the document, such as document creation, review, approval, distribution, implementation, monitoring, revision, archival including retention policy, audit and compliance. Every field may have associated data type. Database of the eQMS also defines the workflows and various fields associated with a workflow such as sequence of stages of the workflow, fields that may be required, updated or locked during the execution of each stage of the workflow, authorized user allowed to perform the various stages of the workflow and the like.

In the event of switching from the source QMS to the destination QMS within the organization, data including all the fields associated with workflows or records defined in the database of the source QMS need to be correctly migrated to the destination QMS. To migrate the data from the source QMS to the destination QMS, the environment 100 may further comprise a system.

The system 106 may be any computing device, such as a server, a desktop computer, laptop, smartphones, or a tablet. The system 106 may comprise one or more processors for executing instructions. In an example, the processor may be implemented as microprocessors, microcomputers, microcontrollers, digital signal processors, central processing units, state machines, logic circuitries, and/or any devices that manipulate signals based on operational instructions. The system 106 may comprise a memory for storing the instructions executable by the one or more processor. The instructions may cause the processor to execute a process of migration of the data. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

In an example implementation, the system 106 may define a standardized protocol comprising a set of rules to be applied to the data to be migrated. The set of rules defines configuration elements for quality control processes implemented in a QMS to manage stages of lifecycle of a product. These elements may include workflows, objects corresponding to various electronic records that may be updated or created during execution of various stages of the workflows, permission sets comprising access rights and restrictions for objects, and various fields associated with objects and the workflows. The configuration elements are defined through the standardized protocol in such a way that all objects or fields that may be required for compliance with regulatory requirements governing the product are captured during migration of the data. For all such objects, the protocol defines rules for extracting the object in a format in which they can be mapped to the destination QMS. Thus, the protocol provides rules for translating the format of the source QMS to the destination QMS.

The system 106 may provide the standardized protocol to a migration device 108 for migration of the data from the source QMS 102 to the destination QMS 104. The migration device 108 may be any computing device, such as a server, a desktop computer, laptop, smartphones, or a tablet. The migration device 108 may comprise one or more processors for executing instructions. In an example, the processor may be implemented as microprocessors, microcomputers, microcontrollers, digital signal processors, central processing units, state machines, logic circuitries, and/or any devices that manipulate signals based on operational instructions. The migration device 108 may comprise a memory for storing the instructions executable by the one or more processor. The memory may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like.

The migration device 108 may be connected to the system 106 and the source QMS via a network (not shown in FIG. 1). In an example, the network may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN). Depending on the technology, the network includes various network entities, such as gateways, routers; however, such details have been omitted for the sake of brevity of the present description.

The migration device 108 may comprise a first application or an extraction application 110 installed therein to extract data from the source QMS 102 and transform the data into the format defined by the standardized protocol as received from the system 106. Workflows, objects, permission sets and fields included in the data are transformed into a corresponding standardized protocol compliant name and type. In an example, the migration device 108 may further comprise a second application or an import application 112 installed therein to import the data of the source QMS 102 transformed into the standardized protocol format to the destination QMS 104.

In an example, the first and the second application may be installed on separate computing devices connected to the system 106 and the destination QMS 104. In various example embodiments, the environment 100 may comprise one, two or three physical devices. One device may correspond to the system 106 and the extraction application 110 and import application 112 may be installed on one or more separate devices or on a single device. In example embodiments, one or more of these devices may have a distributed-computing system based implementation.

The transformation of the data retrieved from the source QMS 102 into a format defined by the standard protocol enables the automatic migration of the data from the source QMS 102 to a destination QMS 104 with reduced probability of errors or inconsistency in data during migration. Since import application 112 understands the format defined by the standardized protocol, the import application can identify the configuration elements of the source QMS encapsulated in the standardized protocol format and configure the destination QMS with the data in the format described by the destination QMS.

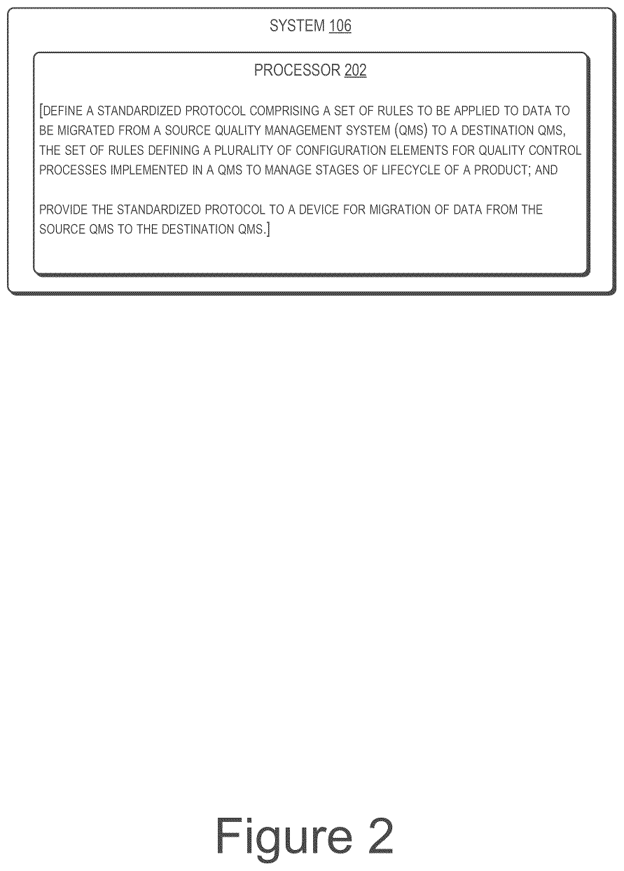

FIG. 2 shows the system 106 for migrating data from the source QMS to the destination QMS, according to an example implementation of the present subject matter. In an example, the system 106 defines a standardized protocol for automatic migration of data from the source QMS to the destination QMS such that the errors that may occur during a manual process of migration are reduced and data is migrated efficiently.

The system 106 may be one or more computing devices, such as desktop computers, laptops, smartphones, personal digital assistants (PDAs), tablets and servers. In an example, the system 106 may comprise a processor 202. In an example, the processor 202 may be implemented as microprocessors, microcomputers, microcontrollers, digital signal processors, central processing units, state machines, logic circuitries, and/or any devices that manipulate signals based on operational instructions.

In an example implementation of the present subject matter, the processor may define a standardized protocol comprising a set of rules to be applied to the data to be migrated. As explained previously with reference to FIG. 1, within a QMS, workflows are defined to carry out various quality control processes managing lifecycle of a product. Each workflow for a quality control process may consist of multiple stages, and one or more actions may be performed by authorized users at each stage to perform a task that may result in modification and creation of one or more electronic records. Objects corresponding to these records have associated fields. For instance, a workflow for approving a product batch might involve stages like inspection, testing, and approval. At the inspection stage, an action could include reviewing batch production records for the product batch to ensure all steps were followed as per manufacturing instructions and that there were no deviations. At the testing stage, actions might include testing the product for specific parameters. At the approval stage, the final approval may be given by an authorized individual.

In an example, the set of rules may define a plurality of configuration elements for quality control processes implemented in a QMS to manage stages of lifecycle of a product. The configuration elements may include workflows, objects corresponding to electronic records that may be updated or created during execution of the workflows and permission sets defining access rights for authorized users of the source QMS. The set of rules ensure that configuration elements, stages of the workflows, actions to be performed at each stage of workflows, and transitions of the quality control processes are carried over correctly from one system to the other. Accordingly, the plurality of configuration elements defined by set of rules comprises at least workflow definitions corresponding to workflows defined for the quality control processes. A workflow definition may comprise a defined sequence of stages of the workflow and actions for the quality control processes executed by the workflow, including transition rules, one or more fields, and configuration of fields for each stage.

In an example implementation, the transition rules corresponding to a stage may define transition of one or more objects corresponding to electronic records in the data from one state to another as a result of one or more actions for compliance with regulatory requirements governing the product. For instance, in the above example, at the inspection stage, a transition rule may specify that after a product batch has passed inspection, the batch record needs to be locked or closed. At the approval stage, a field of the object corresponding to the batch record may be updated to reflect the approval of the product batch. At the approval stage, an action of digitally signing the document may be performed by the authorized individual for compliance with regulatory requirements governing the product. The same may also be updated through a corresponding field of the object. One or more fields that may be associated with a workflow may include sequence of stages of the workflow, fields that may be required, updated or locked during the execution of each stage of the workflow, authorized user allowed to perform the various stages of the workflow and the like. For instance, at the testing stage, required fields of the workflow definitions may comprise fields that may be updated to record test results, with required configurations that may specify the acceptable range of values for certain parameters.

In an example, the processor 202 may provide the standardized protocol to a device, for instance, the migration device 108 for migration of data from the source QMS 102 to the destination QMS 104. On receiving the protocol, the extraction application 110 implemented on the migration device 108 may extract the data of the source QMS 102 and apply the rules defined by the protocol on the data. Once the rules are applied, the configuration elements such as workflows, objects, permissions sets and fields included in the data of the source QMS 102 are mapped into the format defined by the protocol. Since the protocol defines a standard format for a QMS, the import application 112 that may be installed on the migration device 108 may import the data mapped into the standardized protocol format to the destination QMS 104. Name and types of the configuration elements defined in the standard format may be mapped into a format described by the destination QMS 104.

The set of rules established in the standardized protocol specifies a consistent and predefined format for the configuration elements within the QMS. During migration, the configuration elements of the source QMS are retrieved in the standard format and can then be accurately mapped to the corresponding elements in the destination QMS. Thus, with the application of standardized protocol, the challenges typically associated with migrating data between two different QMS platforms are significantly reduced.

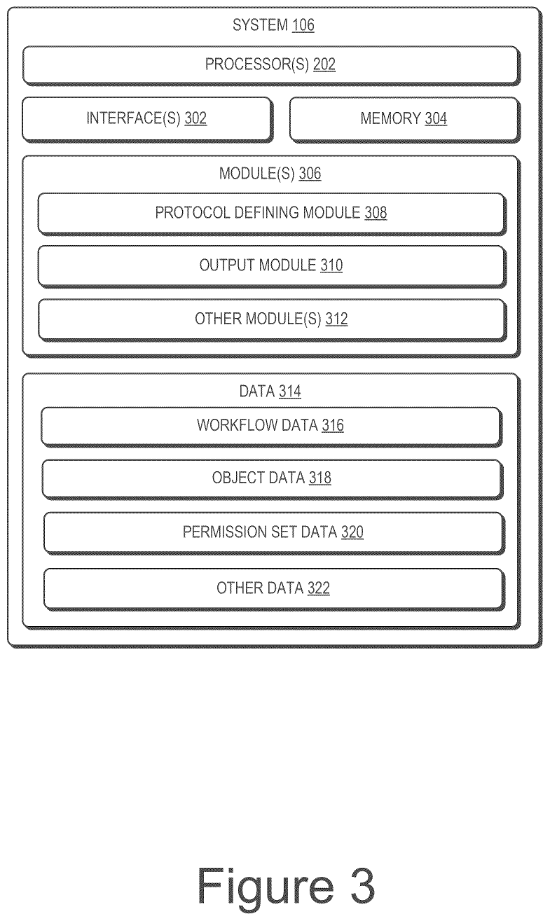

FIG. 3 illustrates the system 106 according to another example implementation of the present subject matter. In an example, the system 106 may be any computing device, such as servers, desktop computers, laptops, smartphones, personal digital assistants (PDAs), and tablets.

In an example, the system 106 comprises a processor, such as the above-described processor 202. In an example, the processor 202 may be implemented as microprocessors, microcomputers, microcontrollers, digital signal processors, central processing units, state machines, logic circuitries, and/or any devices that manipulate signals based on operational instructions. The system 106 also comprises interface(s) 302 coupled to the processor 202. The interface(s) 302 may include a variety of software and hardware interfaces that allow interaction of the system 106 with other communication and computing devices, such as network entities, web servers, and external repositories, and peripheral devices. For example, the interface(s) 302 may couple the system 106 with the migration device 108. The interface(s) 302 may also enable coupling of internal components of the system 106 with each other.

Further, the system 106 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The system 106 may comprise module(s) 306 and data 314 coupled to the processor 202. In one example, the module(s) 306 and data 314 may reside in the memory 304.

In an example, the data 314 may comprise a workflow data 316, object data 318, permission set data 320 and other data 322. The module(s) 306 may include routines, programs, objects, components, data structures, and the like, which perform particular tasks or implement particular abstract data types. The module(s) 306 further includes modules that supplement applications on the system 106, for example, modules of an operating system. The data 314 serves, amongst other things, as a repository for storing data that may be fetched, processed, received, or generated by one or more of the module(s) 306. The module(s) 306 may include a protocol defining module 308, an output module 310 and other module(s) 312. The other module(s) 312 may include programs or coded instructions that supplement applications and functions, for example, programs in the operating system of the system 106.

As explained previously with reference to FIG. 1, the system 106 facilitates migration of data from the source QMS implemented within an organization to the destination QMS. There may be various reasons for migration of data from the source QMS to the destination QMS. For instance, the source QMS may be a legacy application that may have been rendered outdated and may lack certain features that may be provided by the destination QMS. In another example, the migration maybe because of scalability reasons. In an example, the source QMS may be a on-premise-QMS that may be migrated to cloud based platform. In an example, the destination QMS may be one of a cloud-based QMS and on-premise-based QMS.

A QMS automates and optimizes the management of critical documents, policies, procedures, and quality control processes carried out in an organization during lifecycle of a product manufactured by the organization for ensuring product safety, regulatory compliance, and overall effectiveness. By centralizing all documents and data in one secure, easily accessible repository, the QMS streamlines the tracking, approval, and version control of quality control processes and records. This system helps improve the efficiency of quality control processes, reduces manual errors, and ensures that users have up-to-date and accurate information at all times. For this purpose, the QMS comprises features such as document control, change control, non-conformance and corrective and preventive actions (CAPA), complaint management, audit management, training management, supplier quality management, nonconformance tracking and risk management. To facilitate a quality control process managing lifecycle of the product, one or more workflows are implemented in the QMS. A workflow in a QMS may refer to the structured sequence of stages designed to ensure that quality-related activities are carried out effectively and efficiently, aligning with regulatory requirements and organizational standards. For instance, a QMS may include document control workflow, change control workflow, non-conformance and CAPA workflow, complaint workflow, audit workflow, training workflow, supplier management workflow, risk management workflow and the like. During each stage of a workflow, electronic records are created or updated. QMS comprises objects corresponding to each record.

Organizations operating in various industries, such as manufacturing of pharmaceuticals, biotechnology, medical devices, clinical laboratories, contract research organizations (CROs), and other related fields are regulated by regulatory bodies, such as the FDA. Such organizations must comply with the requirements prescribed by the regulatory bodies. For example, regulations may mandate preparation and maintenance of documentation to demonstrate compliance with such regulatory requirements and standards for all existing products within these industries. Thus, the organization may be required to ensure that their QMSs are validated, secure, and capable of maintaining data integrity throughout the lifecycle of the products they are manufacturing/marketing. Accordingly, workflows in the QMSs are configured such that the electronic records created or updated during execution of workflows align with industry standards and regulatory requirements.

For ease of explanation, one example of regulatory requirement relating to electronic signatures is considered. The FDA 21 CFR Part 11 regulations mandate that a QMS include the features, such as system validation to ensure that data handled by the QMS is trusted; record accessibility to ensure that electronic records can be provided or accessed in a human readable format; provide for document storage and record retention to safeguard documentation and retain it for the required period; ensure that only authorized people have access to the QMS; allow secure, computer-generated and time-stamped audit trails generation to capture a complete history of all electronic records; provide for authority checks to ensure limited user access and verify that users performing functions are authorized to do so; enable device checks to verify that equipment used in manufacturing is working properly; provide for training requirements to ensure that only trained and qualified users perform operations; define policies and procedures to manage electronic signatures; and ensure that electronic signatures are securely linked to their corresponding records and cannot be expunged, copied, or transferred without detection.

Data in the source QMS complies with these requirements that are typical of regulated industry. For reliable data transfer between the source and destination QMS, it needs to be ensured that after migration, compliance with these regulatory requirements is still in place. Accordingly, after migration, the destination QMS should continue to comply with the regulatory requirements. Accordingly, during migration, it is important that a regulatory constraint applicable on a record/data is reflected as such to a migrating device such as the migration device 108, so that the data is dealt with accordingly at the time of migration. For example, a record is required to carry a digital signature, this requirement should be made known to the migration device 108 that is migrating the data so that the destination QMS can account for it.

In an example implementation, to migrate the data from the source QMS to the destination QMS, the protocol defining module 308 of the system 106 is operable to define a standardized protocol that comprises a set of rules to be applied to the data to be migrated. The set of rules ensures that properties associated with records and workflows for compliance with regulatory requirements in the data to be migrated are captured correctly and migrated to the corresponding records and workflows in the destination QMS. The set of rules defines a plurality of configuration elements for quality control processes implemented in a QMS to manage stages of lifecycle of a product manufactured by a manufacturer. In an example, the standardized protocol corresponds to a JavaScript Object Notation (J SON)-based descriptor language.

In an example, the plurality of configuration elements may comprise at least workflow definitions corresponding to workflows defined for the quality control processes. The workflow definitions may be stored in the workflow data 316. As mentioned above, a workflow may comprise plurality of stages, each comprising one or more actions for the quality control processes to perform tasks related to quality control activities. For example, a complaint workflow is a structured process that organizations follow to capture, evaluate, resolve, and document customer complaints or any issues related to product quality. This workflow ensures that complaints are managed in compliance with regulatory requirements and are used as opportunities for improvement. A typical complaint workflow in a QMS may comprise stages including complaint receipt and documentation; initial review and acknowledgment; investigation and root cause analysis; corrective and preventive action; implementation and monitoring; closure and communication; review and feedback; compliance and reporting. The complaint receipt and documentation stage may include actions such as complaint logging to record the complaint in QMS; data capture to gather information such as complainant's details, nature of the complaint, product details, and any supporting evidence; and complaint classification to classify complaint by type, e.g., product defect, service issue or safety concern and priority, e.g., low, medium or high. Similarly, the stage of initial review and acknowledgment may include actions such as sending acknowledgment of complaint receipt, for example, in the form or an electronic message, to complainant and preliminary assessment of the complaint for validity to ensure that the complaint is legitimate and pertains to a product or service under the organization's scope. The last stages compliance and reporting may comprise actions such as regulatory compliance to ensure that the complaint resolution process aligns with industry regulations, such as FDA, ISO standards, or other jurisdictional compliance requirements. An action of reporting during this stage may also be performed to generate regular reports on complaints, which may include metrics such as the number of complaints, resolution time, action effectiveness, and root causes. These reports may be used for internal quality monitoring and external compliance audits.

During execution of various stages of the workflow, the actions corresponding to each stage results in creation and updating of one or more electronic records. Owing to which, one or more fields associated with objects corresponding to these records in the data of the QMS may be updated. For example, during execution of the complaint workflow, a complaint record may be created or updated. The complaint record captures necessary details about the complaint or product issue. The fields included in the complaint record help ensure that the complaint is well-documented, processed effectively, and tracked for quality improvement. Object associated with the complaint record or document may have various fields such as complaint ID, complaint date, complainant's name, contact information and geographical location, name of the company or individual affected by the issue, specific product or service related to the complaint, unique identifier for the product, date of purchase or service delivery, category or type of complaint, e.g., product defect, poor service, packaging issue, safety concern, a detailed description of the issue, severity level, any supporting documentation, e.g., images, or videos that help describe the issue.

In an example implementation, the workflow definition may comprise a defined sequence of stages and actions for the quality control processes, including transition rules, one or more fields, and configuration of fields for each stage. The transition rules corresponding to a stage may define transition of one or more objects corresponding to electronic records in the data from one state to another as a result of one or more actions for compliance with regulatory requirements governing the product.

In an example, the one or more actions for compliance with regulatory requirements governing the product may comprise including a digital signature of an authorized user on one or more of the electronic records. According to FDA 21 CFR Part 11 regulations, the system should capture signature information associated with the signing-off a document by an authorized user. A compliant electronic signature must contain printed name of the signer, date and time when the signature was executed and meaning or purpose associated with the signature purpose, such as review, approval, responsibility, or authorship. Furthermore, electronic signatures and handwritten signatures on electronic records must be securely linked to their corresponding records to prevent anyone from removing, copying, or transferring the signature to fake a record.

In an example, the one or more actions for compliance with regulatory requirement may comprise creating an entry in an audit trail associated with an electronic record in an event of a change in the electronic record. An audit trail may be indicative of a history of all actions performed on a record or document, including the user responsible for the action, time when action was performed, and any other relevant details. Accordingly, the entry may comprise change made to the electronic record, identity of a user who performed the change and timestamp. According to FDA 21 CFR Part 11 regulations, audit trails must be secure and automatically generated by the system, must document the time and date of actions performed in the electronic record including creation events, modification events, document approval events, retirement events, include authority checks to ensure that only authorized individuals can use the system, capture and record all performed actions and changes made to the electronic records, not hide or overwrite previously recorded information, be stored for a period that is appropriate for the record based on its content and purpose, be easily accessible for review and copying by the FDA during an inspection. To comply with these requirements, the set of rules ensure that these automatically generated entries in the source QMS during migration are correctly mapped to the destination QMS.

In another example, the one or more actions for compliance with regulatory requirements governing the product may comprise locking one or more of the electronic records to prevent editing to the one or more electronic records. For instance, during initial complaint submission, fields related to the complaint ID, customer information, or date of submission may be locked to prevent unauthorized changes. Similarly, during investigation and review, fields such as complaint status, investigation results, or assigned personnel might be locked to ensure no alterations occur until the next step is reached. Fields may be automatically locked when a certain status is selected, such as moving the complaint to “under investigation” or “resolved.” Once these stages are reached, further edits might be restricted until the next action is taken.

In another example, the one or more actions for compliance with regulatory requirements governing the product may comprise adding annotations to one or more of the electronic records. For instance, during complaint receipt a comment “Complaint submitted regarding defective product received” or “Customer has provided evidence of faulty delivery” may be added to the record by the authorized user.

The one or more actions may result in transition of the corresponding electronic record from one state to another. As mentioned above, the transition rules corresponding to a stage define the transition of one or more objects from one state to another as a result of the one or more actions for compliance with regulatory requirements governing the product. The transition of an electronic record from one state to another may refer to the movement of the workflow through various stages or statuses as it progresses. For instance, when the complaint workflow progresses from the stage of complaint receipt to initial review and acknowledgment, the status of the complaint record may be changed from “New Complaint Submitted” to “Under Review” or “Investigation” and the record may be locked to prevent editing.

In an example implementation, to ensure that the above-described regulatory requirement to be fulfilled during execution of the workflow must be captured correctly, the protocol defining module 308, defines the workflow definition such that it comprises one or more fields associated with the workflow. These fields may include an identifier, name, name of the object corresponding to record to be created or modified during execution of the workflow, sequence of stages of the workflow. The workflow definitions may further comprise one or more fields associated with each stage of the workflow. These fields may include an identifier of the stage, name of the stage, order of the stage in the sequence of stages of the workflow, parent or preceding stage of the stage, indication of whether the stage is starting stage of the workflow, start and end status of the record to be modified or created, fields of the object corresponding to the record that may be required, updated or locked during the execution of each stage of the workflow, authorized users allowed to perform the various stages of the workflow, actions to be performed at the stage and the like. The field associated with the workflow identifying one or more fields of the objects that may be updated or locked during the stage ensures that locked records may be correctly identified during migration and remain in locked state after migration.

In an example implementation, the configuration of fields for each stage may comprise datatype of the field, information comprising description of the field, indication of whether the field is editable or the field may be automatically assigned a value. For instance, fields including an identifier of the stage, name of the stage, order of the stage in the sequence of stages of the workflow may be automatically assigned a value by the system. In an example, fields of object that may be locked during the execution a stage may be updated during execution of the stage depending on the actions performed at the stage.

In an example implementation, the plurality of configuration elements may comprise object definitions. The object definitions may comprise a data structure representing an electronic record type for the quality control processes, including fields with defined data types, field attributes, audit trail configurations, and presentation layouts. The object definitions may be stored in the object data 318. As described above, an object corresponding to an electronic record may be modified or created during one or more stages of a workflow as a result of one or more actions performed at the respective stage. More specifically, one or more fields associated with the object are updated. For instance, during execution of complaint workflow, fields of the object corresponding to the complaint record or document such as complaint ID, complaint date, complainant's name, contact Information and geographical location, name of the company or individual affected by the issue, specific product or service related to the complaint, unique identifier for the product, date of purchase or service delivery, category or type of complaint, e.g., product defect, poor service, packaging issue, safety concern, a detailed description of the issue, severity level, any supporting documentation, e.g., images, or videos that help describe the issue may be updated at the stage of complaint receipt and documentation. Further, fields such as initial assessment comprising information on brief evaluation of the complaint's validity and priority, date at which the complaint was acknowledged by the company or service provider and record of the communication sent to the complainant, including timelines for resolution may be updated at the stage of initial review and acknowledgement. Some of the fields may be updated at various stages of the workflow, for instance, to maintain regulatory compliance and transparency, fields are required to capture information for auditing purposes. For example, field “created by” to identify user who initially submitted or created the complaint; “modified by” to track who last updated the complaint record; “last modified date” to track when the complaint record was last updated; “audit logs” comprising a record of all changes made to the complaint record, such as status changes, field edits, and user actions; and “compliance flags” to indicate whether the complaint is in compliance with internal procedures or external regulations. The data structure representing the electronic record may comprise associated fields and data types of each field.

In an example, to ensure that fields associated with each object in the source QMS behave consistently after migration, the data structure in an object definition may also comprise attributes of each field. The attributes of a field are essential for ensuring that the field captures the necessary data, behaves according to the workflow's rules, and is used correctly by users. Each field typically has multiple attributes that define how the field functions, how it interacts with other fields, and how data is processed and displayed within the workflow. Typical attributes of a field may comprise field name comprising unique identifier or label of the field such as “complaint description,” “priority level,” “resolution date.”; field type indicating type of data stored in the field such as “text or string”, “dropdown/select”, date, checkbox, integer or number, file attachment, radio button and the like; field value comprising actual data or value stored in the field such as “complaint description” might contain the text “Customer reported a defective product”; default value such as “Status” might default to “New” when a complaint is first logged; and field validation rules to ensure that the entered data is correct, complete, and in the expected format such as “required” specifying whether the field must be filled out before proceeding to the next stage, “format” ensuring the data matches a specific format, e.g., date format or email format and “range or value constraint” specifying permissible values or ranges, e.g., the “Priority Level” field can only be set to “Low,” “Medium,” or “High”. Field attributes may further comprise field accessibility to define whether a field is editable, viewable, or locked during different stages of the workflow, based on the user's role or stage of the process, for example, the “complaint ID” field may be locked after submission, while the “complaint status” field remains editable throughout the workflow; field visibility to control which users or user's roles, e.g., customer support representatives, managers, or legal teams can see or interact with the field, for instance, “escalation reason” might be visible only to managers, while “complaint description” is visible to all users. In an example, the field attributes may also include field dependencies to define whether a field's visibility, options, or behavior changes based on the value of other fields. For example, if “complaint type” is selected as “product issue,” then the “product serial number” field becomes visible and if the complaint type is “service issue,” the field may be hidden. Another example of the field attributes may comprise field help text to provide additional instructions or context for the user to understand what data should be entered into the field such as “resolution” field might include a field help text “Select the appropriate resolution action, such as refund or replacement”. Another example of attribute may include information indicating if the field is audit trailed, i.e., whether the changes made to the field value, who made the change, and when it occurred are to be tracked. The attribute may also comprise field history to tracks changes made to the field value, who made the change, and when it occurred. For example, if a user updates the “complaint status” from “under review” to “resolved,” this action may be logged, along with the user's name and timestamp. Field attributes may further comprise field relationship or grouping to organize related fields into groups or sections such as grouping all customer details, e.g., “customer name,” “contact information,” “complaint history” together in a “customer info” section on a layout of the record; field dependencies and triggers to define actions triggered by specific changes in field values, for example, if a complaint status is set to “resolved,” the system might automatically notify the customer or set a follow-up date. The attribute of the field may also indicate if the field contains nested or multidimensional records. In an example, the data structure may also comprise audit trail configurations associated with fields that are required to be audit trailed. The audit trail configurations may comprise log of changes with timestamps and identity of user who made the changes. It may also include information relating to how long the log of changes are to be retained. The provision of attribute comprising an indication of whether the field is audit trailed or not and audit trail configurations in the data structure of object, by the protocol defining module 308, allows for capturing the audit trails in the source QMS 102 correctly.

In an example implementation, the data structure of object definitions may also comprise presentation layouts. Presentation layout may refer to appearance of fields on a graphical user interface that may be coupled to the QMS. The attributes of a presentation layout may comprise list of layout items to be displayed on the user interface and information relating to whether elements such as e-mail checkbox, buttons including radio or action button, highlight panel and how related fields are to be displayed on the layout. The attributes of the layout may further comprise headings of various sections of the layout, fields to be displayed in each section, organization or arrangement of fields and other components that allow interaction of the user with the QMS on the layout. For example, a layout of a complaint record in the complaint workflow may comprise a header section comprising components corresponding to fields complaint ID, customer information, complaint type to be selected through dropdown list, date of submission to be auto-filled, status to be selected through dropdown list, e.g., new, under review, resolved or closed; a main content section comprising fields complaint details, including description, priority and attachments; investigation and review section comprising fields assigned to, investigation notes, additional information requested to be entered via a checkbox, investigation outcome to be selected via dropdown list; resolution section; escalation section; audit section; footer section including action buttons corresponding to actions save draft, submit complaint, assign for investigation, mark as resolved, close complaint, escalate complaint and a comment section for team members or customers to leave comments or updates. The presentation layout in the data structure as defined by the protocol defining module 308 enables to replicate the appearance of records on a graphical user interface of the destination QMS 104 after migration in a similar manner as appeared on the interface of the source QMS.

In an example implementation, the plurality of configuration elements may comprise permission set definitions. The permission set definitions may comprise a collection of access rights and restrictions defining user actions within the QMS, including read, write, and delete permissions for objects and fields, and access rights for the workflows. The permission set definition may be stored in the permission set data 320. The permissions set definitions refers to a structured approach of managing user's access, roles, and responsibilities within the system. It defines what actions a user or group of users can perform on different types of records, ensuring that the appropriate level of access is granted based on the user's role, authority, and the sensitivity of the information. A well-defined permission set ensures confidentiality and security of sensitive data, compliance with relevant standards, such as ISO and FDA and that only authorized personnel can take actions like approving documents, modifying records, or making changes to critical processes. In an example, a collection of access rights and restrictions defining user actions within the QMS may be based on a role-based access control, wherein users are assigned roles that determine their access to different workflows and records, for example based on the designation in the organization. For example, an “Auditor” role might only have access to audit records, while an “Admin” role could have access to all records and settings. A user may have at least one of read, write and delete permissions for objects and fields. Users based on their roles may be authorized to perform actions during execution of various stages of workflows. For example, customer support representatives may have access to the complaint description, complaint status, and investigation notes fields but may not have permissions to change the complaint ID or final resolution. A manager or supervisor may have access to all fields, including escalation fields and final resolution. While a customer might only be able to view specific fields like complaint status and resolution updates, but they cannot edit any fields. Some of the fields may be automatically generated by the QMS and cannot be edited such as complaint ID. Also, any changes to permission sets should be documented and approved by a designated authority to maintain control and prevent unauthorized modifications. Permission set definitions may also be used to verify from the audit trails that if user who performed a change to corresponding field was actually authorized to do so.

In an example implementation, the plurality of configuration elements may further comprise notification definitions. The notification definitions may comprise one or more templates of notifications to be generated to prompt an authorized user to perform the actions for quality control processes. Notification may be generated during execution of workflows in a QMS to ensure effective communication and timely action on critical quality events, tasks, and processes. These notifications alert users about important updates, approvals, non-conformances, changes, or actions that require attention, helping to maintain compliance, improve efficiency, and drive continuous improvement. Notifications may be configured to be sent through various channels, such as emails, in-system messages, or SMS, depending on the preferences and capabilities of the QMS. In an example, notification may be system generated. They are often triggered by specific events or conditions, such as the creation of a new record, upcoming reviews, approvals required, or completion of predefined actions. For example, notification may be generated to alert the responsible persons when a deviation or non-conformance is reported and needs to be addressed and notifications related to CAPA activities, such as when a corrective action plan needs to be implemented or reviewed may be generated. Notifications may be customized and created by, for example, system administrators or managers to address specific needs within the organization such as escalation alerts may be generated if a corrective action or preventive action is overdue, to escalate the issue to a higher authority, during change management relevant users are notified of a change in a document or process to ensure awareness and proper implementation. Further, escalation notifications may be triggered when specific tasks or processes are delayed, or actions are not completed within the required timeframe. Notification definitions may comprise template, triggering events, target user, notification channel, frequency and timing for each notification that may be generated during execution of workflows in the QMS. For example, triggering event for a non-conformance notification may be logging a non-conformance, recipient of this notification may be process owner and quality manager and template or content of notification may include “Non-conformance recorded for batch A. Please review and initiate corrective actions”. During migration, this template of the notification as defined in the source QMS may be mapped to notification definitions as defined in the standardized protocol format defined by the protocol defining module 308. The triggering event, notification channel target user, frequency and timing for this notification may also be identified in the source QMS and mapped to notification definitions to convert the same into the standard format for migration.

In an example implementation of the present subject matter, the output module 310 of the system may provide the standardized set of protocols to a device, for example, the above-described migration device for migration of data from the source QMS to the destination QMS. The set of rules established in the standardized protocol specifies a consistent and standard format for the configuration elements within the QMS. The extraction application running on the migration device may extract data comprising elements such as workflows, objects and permission sets from the source QMS and transforms the data into the standard format by applying the set of rules on the data receive from the source QMS. To transform the data into standard format, the extraction application may extract fields, associated with each element of the QMS such as objects and workflows and maps a name of each field to a name of the corresponding field as defined in the set of rules. The extraction application may determine the data type of each field and based on the type of field captures metadata associated with the field such as field attributes. The extraction application further transforms the workflow stages and corresponding field configuration into the format defined in the set of rules. The extraction application also maps the field type, attributes and presentation layouts associated with each object into the format defined in the set of rules. User's roles and associated access rights are transformed into the format defined by the set of rules. Once the data is transformed into a format as defined in the set of rules, the import application running on the migration device may map the data transformed into the standard format into a format compatible with destination QMS and import the data to the destination QMS. Since, set of rules are designed considering the regulatory requirements associated with a QMS such as those related to audit trails, digital signatures, and lock states, the elements and constraints tied to these regulatory aspects can be precisely extracted and transferred during the migration process. This ensures that important compliance measures are maintained throughout the transition. Thus, the challenges typically associated with migrating data between two different QMS platforms are significantly reduced.

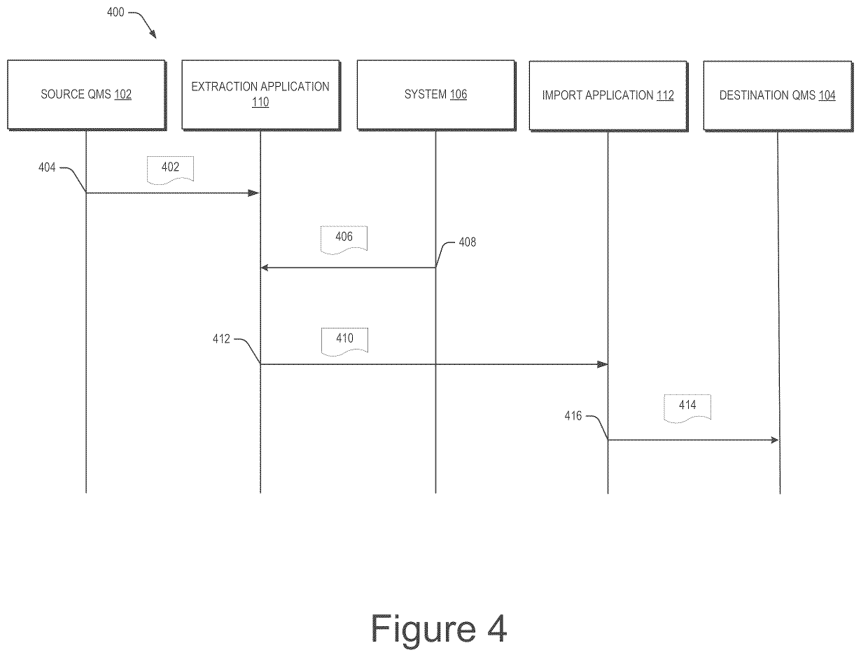

FIG. 4 illustrates a signal flow in a process to migrate data from the source QMS to the destination QMS. As described with reference to FIGS. 1 and 3, to migrate the data 402 of the source QMS 102 to the destination QMS 104, the extraction application 110 running on the migration device 108 receives the data 402 from the source QMS 102 as represented through signal 404. The system 106 provides the standardized protocol 406 comprising set of rules to be applied to the data 402 to be migrated to the extraction application 110 as represented through signal 408. It may be noted that although the example embodiment illustrated through FIG. 4 shows that the data from the source QMS is migrated all at once, all the data of the source QMS to be migrated may not be transferred to the destination QMS 106 together in one big chunk and may be migrated in small portions without deviating from the scope of the present subject matter.

On receiving the data 402 and the standardized protocol 406, the extraction application 110 extracts the configuration elements comprising workflows, objects and permission sets from the data 402. The extraction application 110 identifies fields associated with workflows and objects, maps a name or label of each field to a name as defined in the set of rules and determines the data type of each field. The extraction application 110 further captures the metadata associated with each field based on the data type of field. For example, if the field type is identified as string then metadata may comprise number of characters in the string and if the field type is a pick list, then metadata may comprise valid values in pick list. The metadata may serve as the attributes for the fields of objects and configuration of the fields for the fields tied to workflows. The extraction application 110 also determines stages of the workflows, corresponding fields and configuration of fields associated with the extracted workflows. The extraction application 110 transforms the determined workflow stages and the corresponding field configurations to the standardized protocol format. The extraction application 110 identifies the field types, attributes, and presentation layouts associated with the extracted objects and transforms them into the standardized protocol format. The extraction application 110 ascertains the user's role and associated rights defined in the extracted permission sets and transforms the ascertained user roles and access rights to the standardized protocol format. The transformed data contains the JSON-based data files that encapsulate a plurality of configuration elements of quality control processes defined in the source QMS.

The extraction application provides the J SON-based data files 410 to the import application 112 as represented through signal 412. The import application 112 understands the standard protocol and extracts the plurality of configuration elements including workflow definitions, object definitions and permission set definitions from the data files. In an example, the configuration elements in the destination QMS may be compatible with standardized protocol format and may be imported to the destination QMS in standardized protocol format. Since the standardized protocol format is defined in a language that destination QMS understands, the overhead that may be associated with transforming the configuration elements again in a format described by the destination QMS may be reduced. In another example, the import application may further transform each of the plurality of configuration elements to the corresponding configuration element of the destination QMS 104. The import application provides the data 414 transformed into the format of the destination QMS or in the standardized protocol format to the destination system as represented through the signal 416 to configure the destination QMS with the data 414.

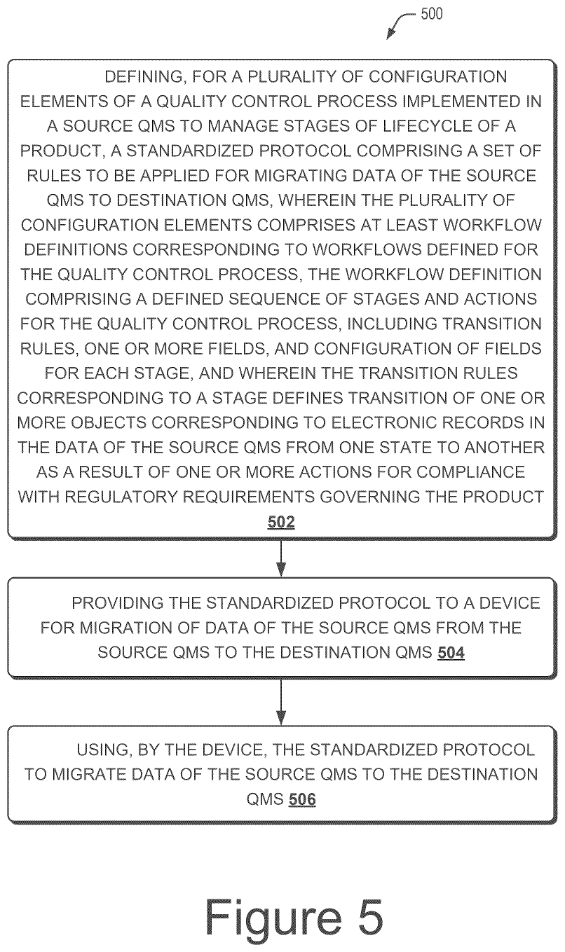

FIG. 5 illustrates a method 500 for migrating data from a source QMS to a destination QMS, according to an example. Although the method 500 may be implemented in a variety of computer-based systems, for the ease of explanation, the present description of the example method 500 to manage building operations is provided in reference to the above-described system 106.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, a standardized protocol comprising a set of rules to be applied for migrating the data of the source QMS 102 to the destination QMS 104 is defined for a plurality of configuration elements of a quality control process implemented in the source QMS to manage stages of lifecycle of a product. In an example, the standardized protocol may be defined by the protocol defining module 308 of the system 106. The plurality of configuration elements comprises at least workflow definitions corresponding to workflows defined for the quality control process.

As described above, workflows are implemented in a QMS to perform quality control processes, and each workflow may comprise plurality of stages designated to perform one or more actions for the quality control process. The one or more actions may be performed in compliance with regulatory requirements such as FDA. One or more electronic records may be created or updated based on the one or more actions. To capture all essentials of a workflow, the workflow definitions defined in the set of rules may comprise a defined sequence of stages and actions for the quality control process, including transition rules, one or more fields, and configuration of fields for each stage.

In an example, the transition rules corresponding to a stage may define transition of one or more objects corresponding to electronic records in the data of the source QMS 102 from one state to another as a result of one or more actions for compliance with regulatory requirements governing the product. For instance, a transition rule may require that a record needs to be locked to prevent further editing to the record. Thus, the action of locking an object corresponding to the record may change the state of the object from editable to locked. An object corresponding to a record may have one or more fields associated therewith. The one or more actions may result in change in state of one or more fields associated with the object. For example, in the complaint workflow, fields related to the resolution, such as resolution type or closure date, may be locked to prevent updates once the complaint is resolved. In an example, the one or more actions for compliance with regulatory requirements may comprise locking one or more of the electronic records to prevent editing to the one or more electronic records, including a digital signature of an authorized user on one or more of the electronic records, adding one or more annotations to one or more of the electronic records or creating an audit trail for an electronic record to record a change made to the electronic record including change, identity of a user who performed the change and timestamp. The one or more fields of the workflow may include but not limited to sequence of stages of the workflow, fields that may be required, updated or locked during the execution of each stage of the workflow, authorized user allowed to perform the stages of the workflow, actions to be performed at the stage and the like.

In an example, the configuration of fields for each stage may define how the fields corresponding to each stage are defined and assigned values. The configuration of fields for a stage may comprise datatype of the field, description of the field, default value of the field, indication of if the field is auto generated and the like.

Once the standardized protocol is defined, the method proceeds to block 504. At block 504, the standardized protocol may be provided to a device, such as the migration device 108 for migration of the data of the source QMS 102 from the source QMS 102 to the destination QMS 104. In an example, the output module 310 of the system 106 may provide the standardized protocol to the migration device 108.

At block 506, the standardized protocol may be used by the device to migrate data of the source QMS to the destination QMS. As described above, the device, for example, the migration device 108 may comprise the extraction application 110 installed therein. The extraction application 110 may extract the data from the source QMS in a format defined by the standardized protocol by applying the set of rules of the standardized protocol. The import application 112 implemented on the migration device 108 understands the standardized format and may import the data extracted in the standardized format to the destination QMS. Accordingly, the format provided by the standardized protocol provides for the automatic migration of the data from the source QMS to destination QMS precisely. Further, the set of rules allows to capture the details concerning the regulatory requirements during migration.

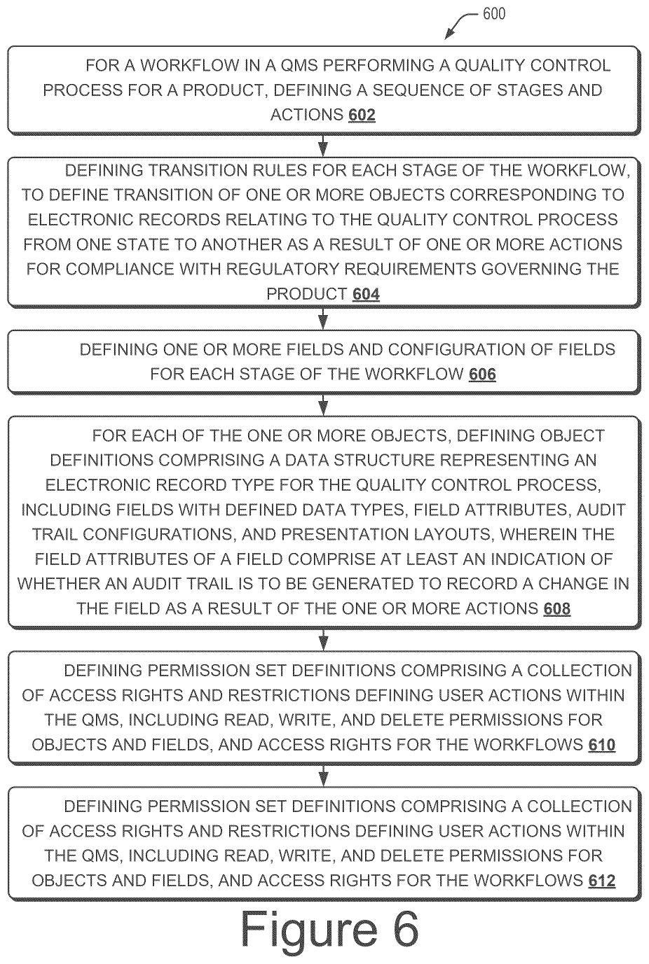

FIG. 6 illustrates a method 600 for defining plurality of configuration elements of a QMS, according to an example. Although the method 600 may be implemented in a variety of computer-based systems, for the ease of explanation, the present description of the example method 600 to manage building operations is provided in reference to the above-described system 106.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or combination thereof.

It may be understood that blocks of the method 600 may be performed by programmed computing devices. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Configuration elements define how quality control processes for managing lifecycle of a product are structured within a QMS. These elements include workflows, objects, permission sets, notifications. For a standard and regulatory complaint QMS, the configuration elements need to comply with regulatory requirements established by regulatory authorities such as FDA.

A workflow in a QMS refers to a series of tasks that need to be executed in a specific order to complete a quality control process. That is, each workflow consists of multiple stages, and each stage of the workflow may contain one or more actions that help to accomplish a particular task within the workflow.

Referring to FIG. 6, at block 602, for a workflow in a QMS performing a quality control process for a product, a sequence of stages and actions are defined. In an example, the sequence of stages and actions are defined by the above-described protocol defining module 308 of the system 106. In an example, a document control workflow may have stages of document creation, document review, document approval, document distribution, document implementation, monitoring and review, document revision and updates, archiving and obsolescence and record keeping. Actions at the stage of document creation may include defining document content, formatting the document according to organization's document standards and the like. The stage of document review may comprise the actions of verifying the correctness, clarity and consistency of the document or updating the document, if necessary, based on feedback from reviewers. Document monitoring and review stage may comprise monitoring document usage and gathering feedback from users and periodically reviewing the document for relevancy. Similarly, document revision and updates may comprise actions of identifying the need for revisions or updates, e.g., based on audits, process changes, updating the document content, number, and revision history and approving the revised document and notifying relevant personnel. Record keeping stage may comprise action of maintaining an audit trail for regulatory compliance and traceability.

At block 604, transition rules for each stage of the workflow may be defined to define transition of one or more objects corresponding to electronic records relating to the quality control process from one state to another as a result of one or more actions for compliance with regulatory requirements governing the product. In an example, the transition rules may be defined by the protocol defining module 308. One or more actions may be performed at each stage in compliance with regulatory requirements such as FDA 21 CFR Part 11. These actions may comprise digitally signing one or more of the electronic records by an authorized user; creating an audit trail for an electronic record to record changes made to the electronic record including identity of a user who performed the change and timestamp; locking one or more of the electronic records to prevent editing to the one or more electronic records; and adding one or more annotations to one or more of the electronic records. The one or more actions performed may lead to the creation of or changes to one or more electronic records. Transition rules define how records flow between the stages, i.e., how objects corresponding to electronic records change from one state to another as a result of one or more actions performed in each stage. The action of including digital signature to approve the document at the document review and approval stage by the approver may change the status of the object from under review to approved. One or more fields may be associated with objects corresponding to the electronic records and may be updated as a result of one or more actions.

At block 606, one or more fields and configuration of fields may be defined for each stage of the workflow. In an example, the one or more fields and the configuration of fields may be defined by the protocol defining module 308. In an example, the one or more fields that may be associated with a stage of the workflow may comprise These fields may include an identifier, name, name of the object corresponding to record to be created or modified during execution of the workflow, sequence of stages of the workflow, identifier of the stage, name of the stage, order of the stage in the sequence of stages of the workflow, parent or preceding stage of the stage, indication of whether the stage is starting stage of the workflow, start and end status of the record to be modified or created, fields of the object corresponding to the record that may be required, updated or locked during the execution of each stage of the workflow, authorized users allowed to perform the various stages of the workflow, actions to be performed at the stage and the like. The configuration of fields may comprise datatype of the field, description of the field, indication of whether the field is editable or the field may be automatically assigned a value.

At block 608, for each of the one or more objects, object definitions may be defined. In an example, the object definitions may be defined by the protocol defining module 308. The object definition may comprise a data structure representing an electronic record type for the quality control process, including fields with defined data types, field attributes, audit trail configurations, and presentation layouts. As mentioned above, the one or more field of an object may be updated as a consequence of actions performed at respective stages of the workflow. For example, fields associated with object corresponding to a document that may be updated during the stage of document creation may comprise document ID, title, type, version, owner, purpose and scope, keywords, review frequency may be updated. Fields like reviewers, comments, approval signatures, approval date may be updated during the stage of document review and approval. Fields distribution list, method, date and access control may be updated at the stage of document distribution, revision number, date, reason, revision history may be updated at the stage of document revision and update. Similarly, fields like audit trail, compliance check, audit findings may be updated at the stage of audit and compliance. The field attributes refer to the specific characteristics or properties of the fields used to capture, track, and manage record throughout its lifecycle. These attributes help define the behavior, format, and constraints of each field, ensuring that the data is consistent, accurate, and compliant with standards. Typical attributes of a field may comprise field name; field type; field value; default value; required specifying whether the field must be filled out before proceeding to the next stage; format to ensure the data matches a specific format, e.g., date format or email format, “range or value constraint” specifying permissible values or ranges, e.g., the “Priority Level” field can only be set to “Low,” “Medium,” or “High”. Field attributes may further comprise field accessibility to define whether a field is editable, viewable, or locked at different stages of the workflow, based on the user's role or stage of the process, for example, the “document ID” field may be locked after initial assignment, while the “document status” field remains editable before approval stage; field visibility to control which users or user's roles, e.g., customer support representatives, managers, or legal teams can view or interact with the field, for instance, “approval signature” might be visible to and editable by authorized approver only, while “document type” may be visible to all users. In an example, the field attributes may also include field dependencies to specify conditions where the visibility or value of one field is dependent on the value of another field. For example, if the document type is set to “procedure”, a field for “process owner” might appear and if the document's status is “active,” the “next review date” field may appear. Another example of the field attributes may comprise field help text to additional information or instructions on how to correctly fill out a field such as tooltip explaining that the version number should follow the format “X.X” (e.g., “1.0”).

Another example of attribute may include field relationship or grouping to organize related fields into groups or sections such as grouping all document information, e.g., “document ID,” “version number,” “document name” together in a “document info” section on a layout of the record. The attribute of the field may also indicate if the field contains nested or multidimensional records. In an example, the field attributes of a field may comprise at least an indication of whether an audit trail is to be generated to record a change in the field as a result of the one or more actions. The audit trail configurations may comprise log of changes made to a field, including who made the change, when it was made, and the previous value. It may also include information relating to how long the log of changes are to be retained.

In an example, presentation layout of a record may refer to the organized structure and arrangement of fields, and other graphical user elements on a graphical user interface coupled to the QMS. A well-defined layout ensures that records are easy to comprehend and aligned with regulatory and organizational standards. Presentation layout may comprise attribute associated therewith. These attributes may include list of layout items to be displayed on the user interface and information relating to whether elements such as e-mail checkbox, control buttons including radio or action button, highlight panel and how related fields are to be displayed on the layout. The attributes of the layout may further comprise headings of various sections of the layout, fields to be displayed in each section, organization or arrangement of fields and other components that allow interaction of the user with the QMS on the layout.

At block 610, permission set definitions may be defined. In an example, the permission set definitions may be defined by the protocol defining module 308. The permission set definitions may comprise a collection of access rights and restrictions defining user actions within the QMS, including read, write, and delete permissions for objects and fields, and access rights for the workflows. The permission sets in a QMS may define levels of access, rights, and privileges that users or user groups have over different records and workflows. These permission sets are crucial for ensuring that only authorized personnel can modify, approve, or review certain information, while maintaining the integrity, confidentiality, and security of the QMS. The access rights and restrictions may be defined based on user's roles and responsibilities in the organization. A user may have at least one of read, write and delete permissions for objects and fields. Each stage has different actions that users can perform, depending on their permissions. Users are assigned specific permissions for each stage of the workflow, ensuring that only the appropriate individuals can perform actions like approving, editing, or finalizing a document at certain points in the workflow. For example, a quality manager or team member can create new SOPs, work instructions, or policies for the organization. However, a user with read access to a document can view the procedure but cannot edit or delete any part of it. A department head may be allowed to review a new procedure before it is officially implemented or distributed. A quality auditor may be allowed to access historical quality control data to perform an internal audit. A document owner may be allowed to update the document's title or approval date but not the content itself. A system administrator may be allowed to assign users to different roles based on their responsibilities, ensuring proper access control.

At block 612, notification definitions may be defined. The notification definitions may be defined by the protocol defining module 308. The notification definitions may comprise one or more templates of notifications to be generated to prompt an authorized user to perform the actions for quality control processes. Notifications are automated alerts or messages sent to users to inform them of specific events, changes, or actions that require their attention within the system. These notifications help ensure that the relevant personnel are kept informed about important activities, tasks, or updates related to records, workflows, compliance, and overall system performance. Notifications help improving efficiency, compliance, and accountability within the organization and ensure that stakeholders are notified in real-time or through scheduled reminders, so that they can take appropriate action when necessary. Notifications may be sent through various channels such as e-mails, SMSs on mobile devices or applications and in-system messages, e.g., pop-up messages or banners within the QMS interface. The notifications may be triggered by specific events such as scheduled review or approval, document creation, document revision, workflow status change, task assignment, regulatory deadlines, scheduled audits, action required, change is document access permission and the like. Thus, notification definitions may also comprise triggering events, target user, notification channel, frequency and timing for each notification that may be generated during execution of workflows in the QMS. For example, notification “Document XYZ is awaiting your approval for release” may be sent, e.g., to manager or department head, when a document is ready for approval and requires a specific person to review and approve it. Similarly, notification “Reminder: The SOP for Product Inspection is due for review in 5 days” may be sent periodically, based on the document review frequency to responsible users. Notification “The document you are working on has moved to the review stage” may be sent to stakeholders or users to keep them informed about the current status of the workflow or document.

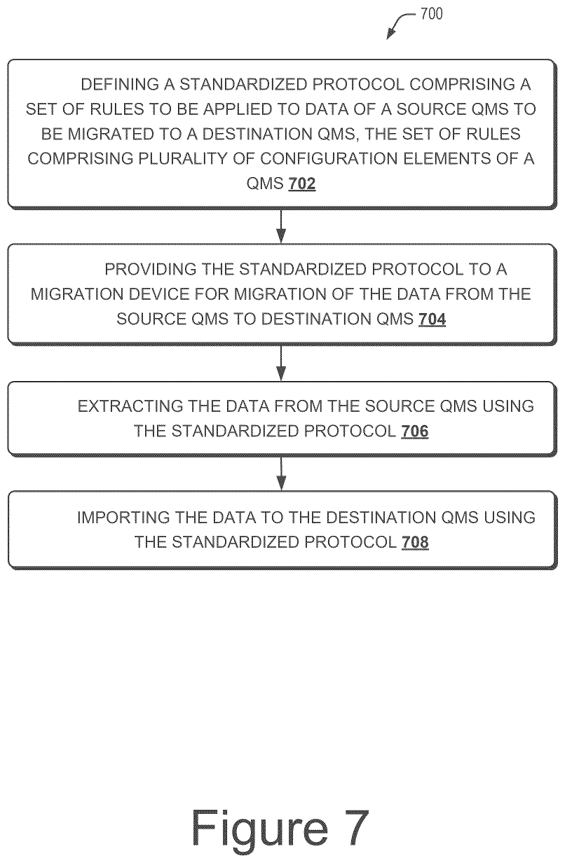

FIG. 7 illustrates a method 700 for migrating data from the source QMS to the destination QMS, according to an example. Although, the method 700 may be implemented in a variety of computer-based systems, for the ease of explanation, the present description of the example method 700 is provided in reference to the above-described system 106.

The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or combination thereof.

It may be understood that blocks of the method 700 may be performed by programmed computing devices. The blocks of the method 700 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 7, at block 702, a standardized protocol may be defined. In an example, the standardized protocol may be defined by the protocol defining module 308 of the system 106. The standardized protocol may comprise a set of rules to be applied to data of a source QMS to be migrated to a destination QMS. The set of rules comprises plurality of configuration elements of a QMS. The plurality of configuration elements of the QMS may comprise workflow definitions, object definitions, permission set definitions, notification definitions. The workflow definitions may comprise a defined sequence of stages and actions for the quality control processes, including transition rules, one or more fields, and configuration of fields for each stage. These elements of the workflow may be defined by the protocol defining module 308 as explained in reference to steps defined in blocks 602-606 of method 600. Object definitions, permission set definitions and notification definitions may be defined by the protocol defining module 308 as explained in reference to steps defined in blocks 608, 610 and 612, respectively, of method 600.

At block 704, the standardized protocol may be provided to a migration device such as migration device 108 for migration of the data from the source QMS to the destination QMS. In an example, the standardized protocol may be provided by the output module 310 of the system 106 to the migration device 108. A standard and consistent format for plurality of configuration elements of the QMS as provided in the set of rules may be used by the migration device 108 to migrate the data from the source QMS to the destination QMS.

At block 706, the data of the source QMS 102 may be extracted from the source QMS 102. In an example, the extraction application 110 implemented on the migration device 108 may extract the data from the source QMS 102. The data of the source QMS 102 may comprise configuration elements defined in the source QMS 102 such as workflows, objects permission sets and notifications. These extracted elements may be mapped by the extraction application 110 to the corresponding configuration element in a format as defined in the set of rules. For instance, the extraction application may extract the fields from the data and determine type of the field. Based on the type of field, the extraction application 110 may capture the metadata associated with the field. For example, if the field type is string, the metadata captured may comprise number of characters in the string, default value and the like. The extraction application may determine the field attributes based on the metadata and wrap the extracted field into a format defined in the set of rules. The extraction application may extract the workflow stages and corresponding field configuration and transform the same into standard protocol complaint name and format. Similarly, extracted objects including the fields, attributes and presentation layouts associated with each object may be transformed into a format defined in the set of rules. Further, user's roles and associated access rights may be extracted and transformed into permission set definitions as defined in the set of rules. Notifications may also be mapped to the corresponding notification definitions defined in the set of rules.

At block 708, the configuration elements of the source QMS transformed into the standardized protocol format may be imported to the destination QMS 104 in a format described by the destination QMS 104. In an example, the import application 112 implemented on the migration device 108 may import the data to the destination QMS 104. To import the data the import application 112 may transform the configuration elements into the format of the destination QMS 104. Accordingly, the standardized protocol ensures that complex structure of workflows, stages, actions, records relating to quality control processes as originally defined in the source QMS 102 are preserved authentically. This guarantees that the destination QMS 104 will properly handle and store the migrated data without any loss of integrity, functionality, or regulatory compliance.

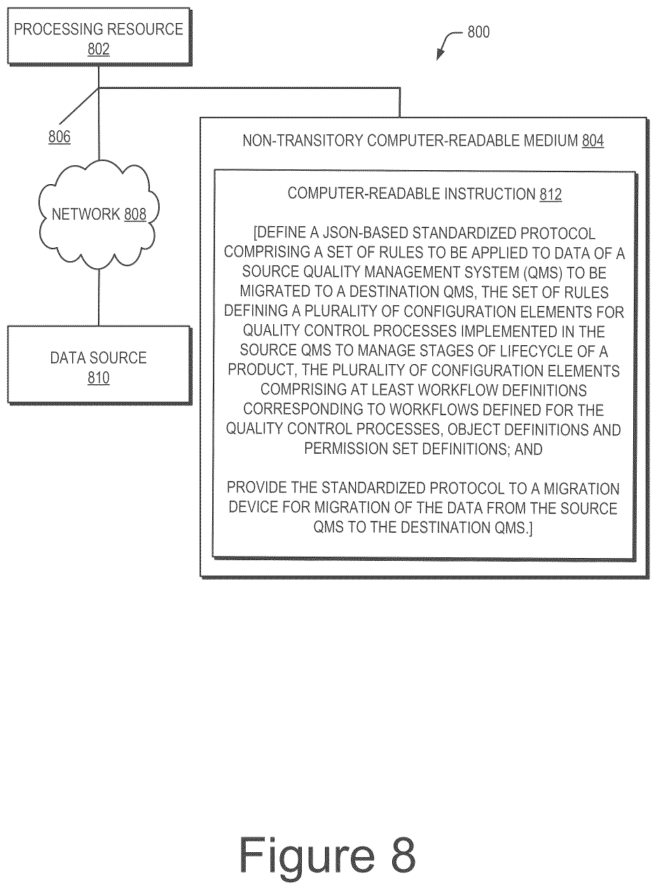

FIG. 8 illustrates a computing environment 800 for migrating data from a source QMS to a destination QMS, according to an example. In an example implementation, the computing environment 800 may comprise a computing device, such as the above-described system 106. The computing environment 800 includes a processing resource 802 communicatively coupled to the non-transitory computer-readable medium 804 through a communication link 806. In an example, the processing resource 802 may be a processor of the computing device, such as the processor 202 of the system 106, that fetches and executes computer-readable instructions from the non-transitory computer-readable medium 804.

The non-transitory computer-readable medium 804 can be, for example, an internal memory device or an external memory device. In an example implementation, the communication link 806 may be a direct communication link, such as any memory read/write interface. In another example implementation, the communication link 806 may be an indirect communication link, such as a network interface. In such a case, the processing resource 802 can access the non-transitory computer-readable medium 804 through a network 808. The network 808 may be a single network or a combination of multiple networks and may use a variety of different communication protocols.

The processing resource 802 and the non-transitory computer-readable medium 804 may also be communicatively coupled to data sources 810. In an example implementation, the non-transitory computer-readable medium 804 comprises executable instructions 812 for migrating the data.

In an example, the instructions 812 may cause the processing resource 802 to define a J SON-based standardized protocol comprising a set of rules to be applied to data of the source QMS to be migrated to the destination QMS. The set of rules defines a plurality of configuration elements for quality control processes implemented in the source QMS to manage stages of lifecycle of a product. The plurality of configuration elements may comprise at least workflow definitions corresponding to workflows defined for the quality control processes, object definitions and permission set definitions.

A workflow in a QMS may comprise a plurality of stages, and each stage may contain multiple actions to accomplish a particular task within the workflow. The workflow definitions may comprise a defined sequence of stages and actions for the quality control processes, including transition rules, one or more fields, and configuration of fields for each stage. The actions may be performed in compliance with regulatory requirements governing the product and may create or update one or more objects in the data. The transition rules corresponding to a stage may define transition of one or more objects in the data of the source QMS from one state to another as a result of one or more actions for compliance with regulatory requirements governing the product. One or more fields may be associated with each object that undergoes the transition and may be updated as a result of one or more actions during a stage of the workflow.

In an example, the one or more actions for compliance with governing the product may comprise including a digital signature of an authorized user on one or more of the electronic records. In another example, the one or more actions for compliance with regulatory requirements governing the product may comprise creating an audit trail for an object or a field of object to record changes made to the object. The audit trail may comprise changes made to the object, identity of a user who performed the change and timestamp. The one or more actions for compliance with regulatory requirements governing the product may also comprise locking one or more of the objects to prevent editing to the objects. The one or more actions for compliance with regulatory requirements governing the product may further comprise adding one or more annotations to one or more of the objects.

In an example, the one or more fields defined for a stage of the workflow may comprise an identifier, name, name of the object to be created or modified during execution of the workflow, sequence of stages of the workflow, identifier of the stage, name of the stage, order of the stage in the sequence of stages of the workflow, parent or preceding stage of the stage, indication of whether the stage is starting stage of the workflow, start and end status of the object to be modified or created, fields of the object that may be required, updated or locked during the execution of each stage of the workflow, authorized users allowed to perform the various stages of the workflow, actions to be performed at the stage and the like. The configuration of fields may comprise datatype of the field, description of the field, indication of whether the field is editable or the field may be automatically assigned a value.

In an example, the object definitions may comprise a data structure of an electronic record representing the data, including fields with defined data types, field attributes, audit trail configurations, presentation layouts. The field attributes may comprise field name; field type; field value; default value; required; format; field accessibility; field visibility; field dependencies; field help text; field relationship or grouping; information indicative of if the field contains nested or multidimensional records; information indicative of whether an audit trail is to be generated to record a change in the field as a result of the one or more actions. The audit trail configurations may comprise changes made to a field, identity of user made the change, timestamp, and the previous value. It may also include information relating to how long the change in audit trail is to be retained. Presentation layout may comprise information relating arrangement of fields, sections and various controls elements such as action button, check box and the like to be displayed on a graphical user interface of the QMS enabling the user to interact with the QMS.

In an example, permission set definitions may comprise a collection of access rights and restrictions defining user actions within the source QMS 102, including read, write, and delete permissions for objects and fields, and access rights for the workflows. In an example, role based access rights may be defined in the permission set definitions.

In an example implementation, the instructions 812 may cause the processing resource 802 to provide the standardized protocol to a migration device for migration of the data from the source QMS to the destination QMS. The migration device may comprise an extraction application 110 to extract the data from the source QMS 102 and transform the data into a standard format specified by the set of rules. The migration device may also comprise an import application 112 to convert the data defined in the standard format into a format described by the destination QMS 104 and import the data in the format compliant with destination QMS 104.

Thus, the methods and systems of the present subject matter provide for migrating data from a source QMS to a destination QMS. Although implementations of migrating data have been described in a language specific to structural features and/or methods, it is to be understood that the appended claims are not necessarily limited to the specific features or methods described. Rather, the specific features and methods are disclosed as example implementations of managing workflows.

1. A system for migrating data from a source Quality Management System (QMS) to a destination QMS, the system comprising:
a processor to:
define a standardized protocol comprising a set of rules to be applied to the data to be migrated, the set of rules defining a plurality of configuration elements for quality control processes implemented in a QMS to manage stages of lifecycle of a product,
wherein the plurality of configuration elements comprises at least workflow definitions corresponding to workflows defined for the quality control processes, the workflow definition comprising a defined sequence of stages and actions for the quality control processes, including transition rules, one or more fields, and configuration of fields for each stage, and wherein the transition rules corresponding to a stage defines transition of one or more objects corresponding to electronic records in the data from one state to another as a result of one or more actions for compliance with regulatory requirements governing the product; and
provide the standardized protocol to a device for migration of data from the source QMS to the destination QMS.
wherein the one or more actions for compliance with regulatory requirements governing the product comprises locking one or more of the electronic records to prevent editing to the one or more electronic records,
wherein the one or more actions for compliance with regulatory requirements governing the product further comprises including a digital signature of an authorized user on one or more of the electronic records, the digital signature being securely linked to a corresponding electronic record.

2. The system as claimed in claim 1, wherein the plurality of configuration elements comprises object definitions, the object definitions comprising a data structure representing an electronic record type for the quality control processes, including fields with defined data types, field attributes, audit trail configurations, and presentation layouts.

3. The system as claimed in claim 1, wherein the plurality of configuration elements comprises permission set definitions, the permission set definitions comprising a collection of access rights and restrictions defining user actions within the QMS, including read, write, and delete permissions for objects and fields, and access rights for the workflows.

4. The system as claimed in claim 1, wherein the plurality of configuration elements comprises notification definitions, the notification definitions comprising one or more templates of notifications to be generated to prompt an authorized user to perform the actions for quality control processes.

5. The system as claimed in claim 1, wherein the destination QMS is one of: a cloud-based QMS and on-premise-based QMS.

6. The system as claimed in claim 1, wherein the standardized protocol corresponds to a JavaScript Object Notation (JSON)-based descriptor language.

7. (canceled)

8. The system as claimed in claim 1, wherein the one or more actions for compliance with regulatory requirements governing the product comprises creating an audit trail for an electronic record to record changes made to the electronic record, the audit trail comprising change made to the electronic record, identity of a user who performed the change, timestamp.

9. (canceled)

10. The system as claimed in claim 1, wherein the one or more actions for compliance with regulatory requirements governing the product comprises adding one or more annotations to one or more of the electronic records.

11. A method for migrating data from a source Quality Management System (QMS) to a destination QMS, the method comprising:
defining, for a plurality of configuration elements of a quality control process implemented in a source QMS to manage stages of lifecycle of a product, a standardized protocol comprising a set of rules to be applied to for migrating data of the source QMS to destination QMS,
wherein the plurality of configuration elements comprises at least workflow definitions corresponding to workflows defined for the quality control process, a workflow definition comprising a defined sequence of stages and actions for the quality control process, including transition rules, one or more fields, and configuration of fields for each stage, and wherein the transition rules corresponding to a stage defines transition of one or more objects corresponding to electronic records in the data of the source QMS from one state to another as a result of one or more actions for compliance with regulatory requirements governing the product;
providing the standardized protocol to a device for migration of data of the source QMS from the source QMS to the destination QMS; and
using, by the device, the standardized protocol to migrate data of the source QMS to the destination QMS,
wherein the one or more actions for compliance with regulatory requirements governing the product comprises locking one or more of the electronic records to prevent editing to the one or more electronic records,
wherein the one or more actions for compliance with regulatory requirements governing the product further comprises including a digital signature of an authorized user on one or more of the electronic records, the digital signature being securely linked to a corresponding electronic record.

12. The method as claimed in claim 11, wherein the plurality of configuration elements further comprises object definitions, the object definitions comprising a data structure representing an electronic record type for the quality control process, including fields with defined data types, field attributes, audit trail configurations, and presentation layouts.

13. The method as claimed in claim 11, wherein the plurality of configuration elements further comprises permission set definitions, the permission set definitions comprising a collection of access rights and restrictions defining user actions within the QMS, including read, write, and delete permissions for objects and fields, and access rights for the workflows.

14. The method as claimed in claim 11, wherein the plurality of configuration elements further comprises notification definitions, the notification definitions comprising one or more templates of notifications to be generated to prompt an authorized user to perform the actions for quality control processes.

15. The method as claimed in claim 11, wherein the one or more actions for compliance with regulatory requirements governing the product comprises creating an audit trail for an electronic record to record changes made to the electronic record, the audit trail comprising change made to the electronic record, identity of a user who performed a change, and timestamp corresponding to the change.

16. The method as claimed in claim 12, wherein the field attributes of a field comprise at least an indication of whether an audit trail is to be generated to record a change in the field as a result of the one or more actions.

17. A non-transitory computer-readable medium comprising instructions executable by a processing resource to:
define a JSON-based standardized protocol comprising a set of rules to be applied to data of a source Quality Management System (QMS) to be migrated to a destination QMS, the set of rules defining a plurality of configuration elements for quality control processes implemented in the source QMS to manage stages of lifecycle of a product,
wherein the plurality of configuration elements comprises at least workflow definitions corresponding to workflows defined for the quality control processes, object definitions and permission set definitions, the workflow definition comprising a defined sequence of stages and actions for the quality control processes, including transition rules, one or more fields, and configuration of fields for each stage, and wherein
the transition rules corresponding to a stage defines transition of one or more objects corresponding to the data of the source QMS from one state to another as a result of one or more actions for compliance with regulatory requirements governing the product,
the object definitions comprising a data structure of an electronic record representing the data, including fields with defined data types, field attributes, audit trail configurations, presentation layouts, and
the permission set definitions comprising a collection of access rights and restrictions defining user actions within the QMS, including read, write, and delete permissions for objects and fields, and access rights for the workflows; and
provide the standardized protocol to a migration device for migration of the data from the source QMS to the destination QMS,
wherein the one or more actions for compliance with regulatory requirements governing the product comprises locking one or more of the electronic records to prevent editing to the one or more electronic records,
wherein the one or more actions for compliance with regulatory requirements governing the product further comprises including a digital signature of an authorized user on one or more of the electronic records, the digital signature being securely linked to a corresponding electronic record.

18. The non-transitory computer-readable medium of claim 17, wherein the plurality of configuration elements further comprises notification definitions, the notification definitions comprising one or more templates of notifications to be generated to prompt an authorized user to perform the actions for quality control processes.

19. (canceled)

20. The non-transitory computer-readable medium of claim 17, wherein the one or more actions for compliance with regulatory requirements governing the product comprises adding one or more annotations to an electronic record.

21. The system as claimed in claim 1, wherein the workflow definition further comprises, for each stage, an identification of one or more fields of objects corresponding to the electronic records that are to be locked during execution of the stage, such that locked records remain in locked state after migration.

22. The system as claimed in claim 1, wherein the digital signature comprises at least one of a printed name of a signer, and a date and time when the digital signature was executed.

23. The system as claimed in claim 1, wherein the plurality of configuration elements further comprises notification definitions, the notification definitions comprising, for each notification, at least one of a template, a triggering event, a target user, a notification channel, and a frequency and timing, and permission set definitions based on role-based access control, wherein users are assigned roles that determine their access to different workflows and records based on a designation in an organization.
